(19) United States
(12) Patent Application Publication
(10) Pub. No.: US 2023/0033972 A1
(43) Pub. Date: Feb. 2, 2023

(54) Roof for a Motor Vehicle, Motor Vehicle Having a Roof, Assembly Kit for a Roof and Method for Mounting a Roof

(71) Applicant: Webasto SE, Stockdorf (DE)

(72) Inventors: Michael HUELSEN, Stockdorf (DE); Cedric LANGLAIS, Stockdorf (DE); Michael MAILHAMER, Stockdorf (DE); Juraj LEHOTSKY, Stockdorf (DE)

(21) Appl. No.: 17/791,468

(22) PCT Filed: Jan. 20, 2021
(86) PCT No.: PCT/EP2021/051183

§ 371 Date: Jul. 7, 2022

(30) Foreign Application Priority Data
Feb. 7, 2020 (DE) 10 2020 103 158.0

(51) Int. Cl. B62D 25/06; B60R 11/04

(52) U.S. Cl. CPC B62D 25/06; B60R 11/04

(57) ABSTRACT

A roof for a motor vehicle, in particular for a passenger car, having a roof skin, a support structure, over which the roof skin engages, and at least one sensor module having at least one environment sensor for detecting the vehicle environment. The sensor module is mounted on the support structure and a tolerance-compensating element, which defines a relative position between the support structure and the sensor module, is disposed between the support structure and the sensor module.

The invention relates to a roof for a motor vehicle, in particular for a passenger car, comprising the features of the preamble of claim 1, to a motor vehicle having a roof, to an assembly kit for a roof of a motor vehicle and to a method for mounting a roof of a motor vehicle.

A roof of the kind described above is known from practice and is formed in particular as a component of a vehicle roof of a passenger car and as a roof module. The roof module is a separate component, which can be fitted on roof side rails for forming the vehicle roof, the roof side rails being a component of a vehicle body forming a vehicle shell structure. As an intersection with the roof side rails and as an element, which gives the roof module its stiffness, the roof module usually has a support structure which can be formed by a roof frame. A roof skin, which forms the outer viewing area of the roof module, engages over the support structure. The roof module can be formed as an entirely fixed roof element which has a transparent roof portion forming a roof see-through portion in the case of a panoramic roof. For forming the roof see-through portion, the roof skin is transparent in the respective portion. Alternatively, the roof module can have a roof opening system which comprises a displaceable lid element, by means of which a roof opening can be opened or closed selectively. In the case of a roof module having a roof opening system, the roof skin reaches up to the roof opening.

Furthermore, it is known to dispose a sensor module on a vehicle roof provided with a roof to allow autonomous or semi-autonomous driving of the respective motor vehicles. Such sensor modules can comprise environment sensors, by means of which a vehicle environment can be monitored and detected. Based on the monitoring or detection signals, the motor vehicle can be controlled in an autonomous or semi-autonomous driving mode by means of a corresponding control device. The sensor modules which have been used so far with autonomous or semi-autonomous motor vehicles are fitted on the roof skin of the motor vehicle. Thus, the sensor modules form the highest point of the respective vehicle. However, sensor modules which are formed as an attachment have an appearance that does not meet customer requirements.

It is necessary that the environment sensors or sensor modules are positioned very accurately relative to the vehicle shell structure so that precise and exact measurements of the vehicle environment are possible by means of the sensor modules. Additionally, the field of view of the environment sensors should not be impaired. So the tolerance requirements are very high. However, the dimensions and geometries of support structures of different vehicles of a particular production series can deviate from each other.

The object of the invention is to provide a roof of the kind described above in which the sensor module is positioned accurately relative to the support structure. The object of the invention is also to provide a motor vehicle having a roof of this kind, an assembly kit for a roof of this kind and a method for assembling a roof of this kind.

These objects are attained by the roof having the features of claim 1, the motor vehicle having the features of claim 8, the assembly kit having the features of claim 9 and by the method having the features of claim 12.

So the invention proposes a roof in which a sensor module is mounted on a support structure, over which the roof skin engages, a tolerance-compensating element, which defines a relative position between the support structure and the sensor module, being disposed between the support structure and the sensor module. The tolerance-compensating element has exactly the geometry required for providing an accurate positioning between the support structure and the sensor and for adhering to the allowed tolerances between the sensor module and a vehicle shell structure, to which the support structure is connected. The tolerance-compensating element is a precisely prefabricated intermediate element, which is introduced between the support structure and the sensor module as an insert and which allows the low tolerances which must be adhered to with environment sensors regarding their position relative to the vehicle shell structure and which may only amount to a few tenths of a millimeter and only a few degrees or a few tenths of a degree to be adhered to in the three spatial directions.

In a preferred embodiment of the roof according to the invention, the tolerance-compensating element is a tolerance-compensating plate on which the sensor module rests.

The tolerance-compensating element can have holes or differently designed fixing points, which allow it to be mounted on the sensor module and/or the support structure. In the assembled state, the sensor module rests on the tolerance-compensating plate.

To also be able to define the angle between the sensor module and the support structure, the tolerance-compensating element has a wedge-shaped or trapezoidal cross section in a specific embodiment of the roof module according to the invention. The wedge-shaped or trapezoidal design of the tolerance-compensating element can be chosen in particular such that an angle of the sensor module relative to the support structure is adjusted in two spatial directions with respect to the alignment of the respective motor vehicle. Alternatively, the tolerance-compensating element can also be a simple wedge having a rectangular surface area which has a cut on its pointed side, if necessary, whose angle only opens in one spatial direction with respect to the vehicle alignment.

The support structure of the roof according to the invention is, for example, a roof frame or part of a roof frame or is connected to a roof frame, which, when mounted on a vehicle, preferably forms an intersection with a vehicle shell structure which can be formed in particular by roof rails, such as roof side rails. The roof frame can be circumferential or simply comprise individual frame segments. The support structure can also be an additional element which is connected to the frame or a respective frame segment.

In an embodiment of the roof according to the invention which meets high design requirements, the roof skin engages over the sensor module. Thus, the sensor module is accommodated by the roof module in a compact manner.

Advantageously, the roof skin, which engages over the sensor module, is provided with a sensor see-through portion via which the environment sensor can detect the vehicle environment and which is formed as a cutout or glazing.

The environment sensor of the roof according to the invention can have various designs, use electromagnetic radiation and/or acoustic waves, and comprise, for example, a lidar sensor, a radar sensor, an optical sensor, such as a camera, an antenna device and/or the like. If the environment sensor is a lidar sensor, it preferably operates within a wavelength range of approximately 905 nm or even approximately 1550 nm. A camera used as an environment sensor can operate within the wavelength range of visible light and/or in the infrared range. The sensor see-through portion, which is formed on the roof skin, is transparent in particular for wavelengths which are used by the environment sensor(s) and preferably for a wavelength range between 200 nm and 2000 nm. Advantageously, the sensor see-through portion is also transparent for radar beams.

The invention in particular provides a roof module or roof sensor module (RSM) which allows autonomous or semi-autonomous driving of the respective vehicle.

A vehicle which is provided with the roof according to the invention and which is formed as an autonomously driving vehicle drives independently in an autonomous driving mode, at least without a driver significantly interfering. In a semi-autonomous driving mode of a motor vehicle, the roof according to the invention forms a part of a driver assistance system, for example.

In particular, the roof according to the invention comprises a roof module, in which components necessary for autonomously or semi-autonomously driving the respective vehicle are accommodated in an integrated manner. The roof, which can have a plurality of functional elements, forms a compact modular unit, which can be connected to a vehicle body or a vehicle shell structure by a vehicle manufacturer for forming a vehicle roof, the vehicle body or vehicle shell structure advantageously comprising roof rails, such as side rails, between which the roof module is accommodated.

The roof according to the invention can be provided with a continuously fixed roof skin or also with a roof opening system which selectively opens or closes a roof opening of the roof skin by means of a lid element. The roof skin can also form a roof see-through portion which constitutes a transparent fixed roof portion. The roof according to the invention is in particular a component of a passenger car; however, it can also be used with a commercial vehicle designed as a delivery truck, an autonomously driving minibus, such as a people mover, a bus, or even a tractor unit, for example.

Subject matter of the invention is also a motor vehicle which comprises a roof of the kind described above. The motor vehicle can generally be any road-bound, rail-bound or water-bound vehicle, but it is preferably a passenger car or a commercial vehicle.

Furthermore, subject matter of the invention is an assembly kit for a roof of a motor vehicle, in particular for a passenger car, the assembly kit comprising a support structure and at least one sensor module having at least one environment sensor, which is mountable on the support structure, and a plurality of tolerance-compensating elements which have different dimensions and can each be disposed between the sensor module and the support structure when the sensor module is being fixed on the support structure. Thus, the assembly kit comprises a set of tolerance-compensating elements, of which at least one is selected during the assembly or when the roof is assembled in accordance with the determined geometry of the support structure and/or the sensor module and is disposed between the sensor module and the support structure.

Advantageously, at least one of the tolerance-compensating elements of the selection of tolerance-compensating elements has a wedge-shaped or trapezoidal cross section such that an angle adjustment between the sensor module and the support structure is possible.

Preferably, several of the tolerance-compensating elements have a wedge-shaped and/or trapezoidal cross section, the wedge angles of these tolerance-compensating elements being different and/or these tolerance-compensating elements having different trapezoidal angles and/or different trapezoidal heights.

Additionally, the tolerance-compensating elements can have different thicknesses and/or can also be formed as shims having parallel large surfaces.

Furthermore, subject matter of the invention is a method for mounting a roof of a motor vehicle, in particular of a passenger car, the method comprising the following steps:
providing a support structure;
providing at least one sensor module having at least one environment sensor;
measuring the support structure and/or measuring the sensor module for determining the dimensions of the support structure and/or the sensor module;
selecting a tolerance-compensating element from a plurality of tolerance-compensating elements having different dimensions in accordance with the dimensions of the support structure and/or the sensor module; and
fixing the sensor module on the support structure, the selected tolerance-compensating element being disposed between the support structure and the sensor module.

By measuring the support structure and/or the sensor module, the relative position between the sensor module and the vehicle shell structure which would occur without the tolerance-compensating element and which can be corrected by means of the tolerance-compensating element can be determined. The tolerance-compensating element is mounted on the support structure along with the sensor module.

A roof frame, which can in particular already be provided with a roof skin, is preferably provided as a support structure. The roof skin can have an opening via which the sensor module can be mounted on the support structure.

Further advantages and advantageous embodiments of the subject matter of the invention can be derived from the description, the drawing and the patent claims.

An embodiment of the subject matter of the invention is illustrated schematically simplified in the drawing and is described in more detail hereinafter.

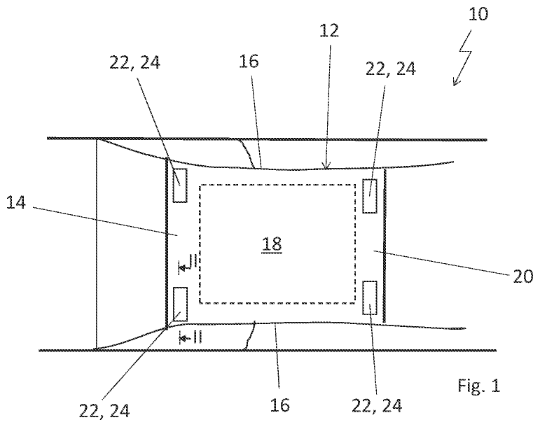

FIG. 1 shows a schematic top view of a vehicle roof having a roof module;

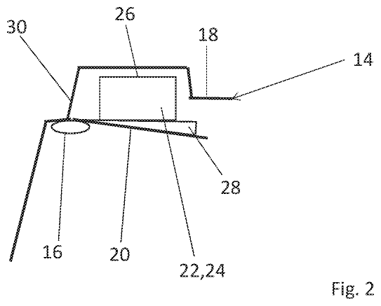

FIG. 2 shows a sectional view of the vehicle roof according to FIG. 1 along line II-II in FIG. 1; and

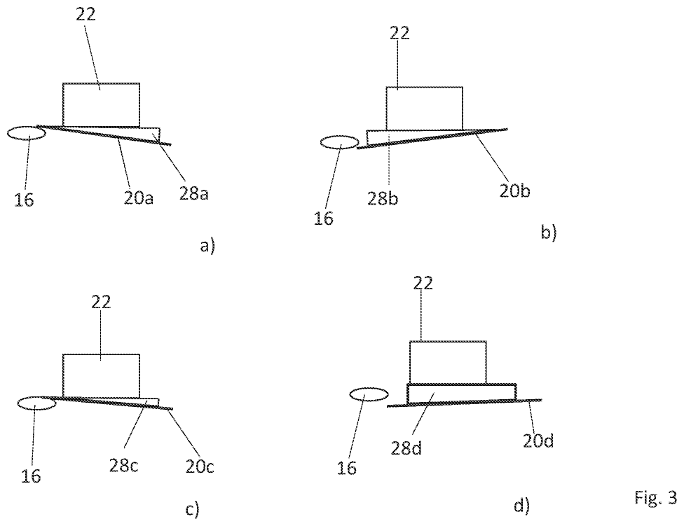

FIGS. 3a to d each show a sensor module on a support structure of the roof module having different tolerance-compensating elements.

FIG. 1 illustrates a motor vehicle 10 which is formed as a passenger car and has a vehicle roof 12 which covers a vehicle interior. Vehicle roof 12 comprises a roof module 14 which is disposed between roof side rails 16 which are disposed on either side of a vertical longitudinal center roof plane and which form the lateral edges of vehicle roof 12. Roof side rails 14 are components of a vehicle body representing a vehicle shell structure.

As can be gathered from a combined view of FIGS. 1 and 2, roof module 14 comprises a roof skin 18 and a frame-like support structure which is a roof substructure and forms an intersection of roof module 14 with roof side rails 16.

Roof module 14 is a roof sensor module (RSM) which is provided with devices that allow motor vehicle 10 to be driven autonomously. To this end, roof module 14 has a sensor technology which comprises a sensor module 22 in each of the four corner areas of the vehicle roof, sensor module 22 being equipped with environment sensors 24 by means of which the vehicle environment can be detected for realizing autonomous driving. Each environment sensor 24 is disposed on or in a housing 26 which is disposed on support structure 20 via a tolerance-compensating element 28 wedge-shaped in cross section. Tolerance-compensating element 28, which is formed in the manner of a tolerance-compensating plate, is a precisely prefabricated component, which ensures the accurate positioning of sensor module 22 relative to support structure 20 and thus relative to roof side rails 16.

Roof skin 18 engages over both support structure 20 and sensor modules 22. In the area of each sensor module 22, a side wall 30 is formed on roof skin 18, side wall 30 forming a sensor see-through portion for each environment sensor 24 of respective sensor module 22.

Environment sensors 24 of sensor modules 22 can have various designs and comprise a lidar sensor, a radar sensor, a camera and/or another suitable sensor, for example. Side walls 30 of roof skin 18 can each be formed as a roof skin insert and are transparent for the wavelengths used by environment sensors 24. In particular, side walls 30 are transparent for wavelengths between 200 nm and 2000 nm and also for radar beams.

Environment sensors 24 are connected to a control device (not further illustrated) of motor vehicle 10. By evaluating and analyzing the measuring signals of environment sensors 24 by means of the control device, a respective traffic situation can be determined such that motor vehicle 10 can autonomously or independently adjust to the respective traffic situation and act accordingly.

It is necessary for the production of roof module 14 that sensor modules 22 are positioned accurately relative to the shell structure of motor vehicle 10. The intersection with the shell structure is formed, as described above, by support structure 20 of roof module 14. However, the dimensions and geometries of support structure 20 and sensor modules 22 may not always correspond to the predetermined value. Thus, the geometry of support structure 20 is measured during the production of roof module 14 such that the dimensions and geometry of the same can be determined. Accordingly, the geometry of sensor module 22 or housing 26 of sensor module 22 can also be measured such that its dimensions and geometry are also known. In accordance with the determined dimensions and geometries, a specific tolerance-compensating element 28 is selected from a plurality of stocked compensating elements which differ with regard to their geometry (thickness, wedge angle, trapezoid etc.) and used as an intermediate element or spacer, via which respective sensor module 22 is mounted on or fixed to support structure 20. By means of tolerance-compensating element 28, sensor module 28 is fixed accurately in terms of position and/or angular position.

Thus, an assembly kit for the production of roof module 14 comprises at least support structure 20, four sensor modules 22 and a plurality of tolerance-compensating elements which have different geometries and which can be disposed between sensor module 22 and support structure 20 when respective sensor module 22 is being fixed on support structure 20.

FIGS. 3a to 3d show support structures 20a, 20b, 20c and 20d which differ with regard to their inclination relative to a roof side rail 16. To nonetheless provide sensor module 22, which is to be positioned on the respective support structure 20a, 20b 20c or 20d, with an accurate relative position relative to roof side rail 16, a corresponding wedge-like tolerance-compensating element 28a, 28b, 28c or 28d is inserted between sensor module 22 and support structure 20a, 20b, 20c or 20d. Tolerance-compensating element 28a differs from tolerance-compensating element 28c with regard to the wedge angle. Tolerance-compensating element 28b differs from tolerance-compensating elements 28a and 28c with regard to the tapering direction of the formed wedge. Tolerance-compensating element 28d has a trapezoidal cross section.

### REFERENCE SIGNS

10 motor vehicle

12 vehicle roof

14 roof module

16 roof side rail

18 roof skin

20 support structure

22 sensor module

24 environment sensor

26 housing

28 tolerance-compensating element

30 side wall

1. A roof for a motor vehicle comprising:
a roof skin,
a support structure, over which the roof skin engages, and
at least one sensor module having at least one environment sensor for detecting the vehicle environment,
wherein the sensor module is mounted on the support structure and a tolerance-compensating element, which defines a relative position between the support structure and the sensor module, is disposed between the support structure and the sensor module.

2. The roof according to claim 1, wherein the tolerance-compensating element is a tolerance-compensating plate on which the sensor module rests.

3. The roof according to claim 1, wherein the tolerance-compensating element has a wedge-shaped, trapezoidal or rectangular cross section.

4. The roof according to claim 1, wherein the support structure is a roof frame or part of a roof frame or is connected to a roof frame, which, when mounted on a vehicle, preferably forms an intersection with a vehicle shell structure.

5. The roof according to claim 1, wherein the roof skin engages over the sensor module.

6. The roof according to claim 1, wherein the roof skin is provided with a sensor see-through portion via which the environment sensor detects the vehicle environment.

7. The roof according to claim 1, wherein it is a roof module which is connectable to a vehicle shell structure as a unit.

8. A motor vehicle, comprising a roof according to claim 1.

9. An assembly kit for a roof of a motor vehicle, comprising:
a support structure,
at least one sensor module which has at least one environment sensor and which is mountable on the support structure, and
a plurality of tolerance-compensating elements, which have different dimensions and are each disposed between the sensor module and the support structure when the sensor module is being fixed on the support structure.

10. The assembly kit according to claim 9, wherein at least one of the tolerance-compensating elements has a wedge shape, trapezoidal or rectangular cross section.

11. The assembly kit according to claim 10, wherein several of the tolerance-compensating elements have a wedge shaped and/or trapezoidal cross section, different wedge angles being formed on these tolerance-compensating elements and/or these tolerance-compensating elements having different trapezoidal angles and/or different trapezoidal heights.

12. A method for producing a roof of a motor vehicles, comprising the following steps:
providing a support structure;
providing at least one sensor module having at least one environment sensor;
measuring the support structure and/or measuring the sensor module for determining the dimensions of the support structure and/or the sensor module;
selecting a tolerance-compensating element from a plurality of tolerance-compensating elements having different dimensions in accordance with the dimensions of the support structure and/or the sensor module; and
fixing the sensor module on the support structure, the selected tolerance-compensating element being disposed between the support structure and the sensor module.

13. The method according to claim 12, wherein a roof frame, which is preferably provided with a roof skin, is provided as the support structure.
